(19) United States
(12) Patent Application Publication
(10) Pub. No.: US 2014/0225727 A1
(43) Pub. Date: Aug. 14, 2014

(54) TURNING SIGNAL

(71) Applicant: Sarfaraz K. NIAZI, Deerfield, IL (US)

(72) Inventor: Sarfaraz K. NIAZI, Deerfield, IL (US)

(21) Appl. No.: 13/764,147

(22) Filed: Feb. 11, 2013

(51) Int. Cl. B60Q 1/34

(52) U.S. Cl. CPC B60Q 1/34
USPC 340/471; 340/475

(57) ABSTRACT

Turn signals for moving vehicles along both sides of the vehicle are reported.

### BACKGROUND OF THE INVENTION

This invention relates to lighting devices installed along the sides of moving vehicles as turning signals to improve their visibility when changing lanes or turning and thereby preventing accidents.

### BRIEF SUMMARY OF THE INVENTION

Despite significant improvements in automotive lighting, there remains an unmet meet for a structure to improve the safety of moving vehicles in traffic using specific arrangements of lights on the outside of the moving vehicle to eliminate the blind spot when two moving vehicles are simultaneously changing lanes.

One of the greatest numbers of accidents takes place when cars are changing lanes. According to a report by the Department of Transportation, U.S. Government (DOT-VNTSC-NHTSA-02-03, DOT HS 809 571 March 2003), there were more than half a million (over a million vehicles involved) accidents while changing lanes on the road. Because of the nature of collisions involved while changing lanes, the damage to both moving vehicles is significantly higher than the rear collisions. The reason for this high incidence of collisions when changing lanes comes from the inevitable blind spot when two moving vehicles are approximately at the same position but in different lanes; more typically, in a three lane road, two moving vehicles entering the middle lane simultaneously will collide as neither driver would know the intention of the other driver despite the illumination of currently installed turn signals, as these will not be clearly visible to either driver.

### BRIEF DESCRIPTION OF THE DRAWING

FIG. 1 is the left side view of an automobile (1) with strips of lights (2) installed along the entire side length of the automobile.

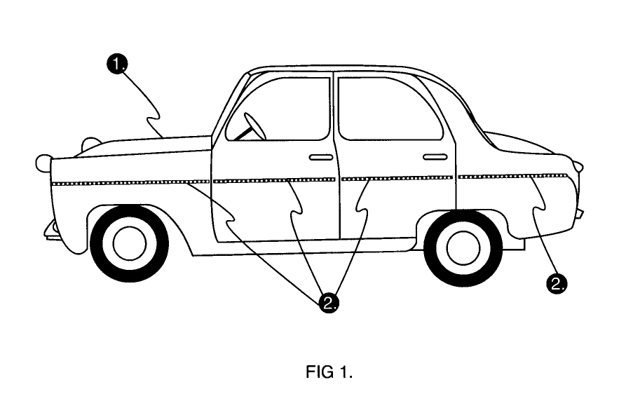

FIG. 2 is the left side view of an automobile (1) with strips of lights (2) installed along the entire side length of the automobile but at different positions.

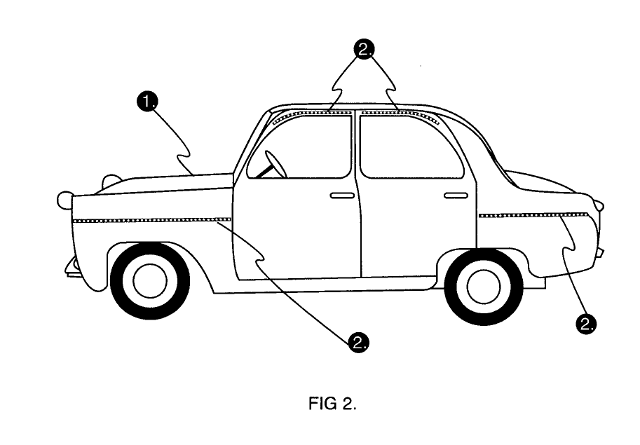

### DETAILED DESCRIPTION OF THE INVENTION

According to the invention, there is provided a lighting system for a turn signal for a moving vehicle, comprising a plurality of lights, preferably, LEDs, installed along both sides of a moving vehicle, preferably from the front end to the rear end and affixed just below windows, above the windows or split between both of these positions.

These turn signals will be readily and clearly visible to merging moving vehicles and thus avoid substantial risk to assets and lives.

Whereas the turn signals currently used, both installed in or above the bumpers and in the exterior mirrors, are inadequate in warning if two moving vehicles are intending to change the lanes on a roadway simultaneously, this contributes to most accidents on the roads. By providing a plurality of lights or continuous strips that run the entire length of both sides of a moving vehicle, the turn signal, in addition to the currently used arrangement of turn signals, will provide a wrap-around visibility of the moving vehicle.

In the reported invention, a moving vehicle is illuminated on both its sides by a narrow strip with embedded LEDs; this reduces the space required to install the lights.

LEDs are more and more used in automotive lighting. LEDs are now found in lighting modules of moving vehicles that were previously exclusively reserved for filament light bulbs. A third (central) brake light in vehicles is now commonly implemented with LED technology, and it is expected that LEDs will in the future be used for all light units. The 2014 S class model of Mercedes cars would contain an all LED lighting system, both for external and internal lights. The efficiency, durability and small form factor of LEDs is particularly attractive for automobile lighting modules.

The turn signals provided on both sides of an automobile can also be electronically programmed to turn on and off in specific patterns such as in a string, off and on, or any other sequence to enhance the alertness. However, even the synchronization with the currently installed turn signals will be adequate in most instances.

The turn signals provided can also be used as hazard signals.

The instant invention will be equally useful for all types of moving vehicles, from tall trucks to small cars, two-wheeled vehicles and a variety of recreational vehicles.

The LEDs used can be of mono light type where the LED emits only one color of light (amber or red) or the RGB type wherein the same LED can emit lights of different colors and where the output is controlled electronically.

The invention can be implemented in different combinations of the clusters of LEDs switched on or off simultaneously. The number of LEDs lit at one time can also be varied depending on the intensity of light desired. The color, position of installation, the intensity of light and the size of lights must meet all requirements of the regulatory agencies.

Various modifications will be apparent to those skilled in the art.

What is claimed is:

1. A turn signal for moving vehicles comprising:
a plurality of lights affixed on both sides of the moving vehicle along substantially the entire length of the vehicle;
an electronic controller to turn on and off the lights in synchronization with other turn signals in current use; and,
an electronic controller to turn on and off the lights in a pre-determined pattern, frequency and intensity.

2. The turn signal according to claim 1, wherein the plurality of lights are affixed at the roof level, at a level below the windows or at the bumper level or a combination thereof.

3. The turn signal according to claim 1, wherein the plurality of lights are light emitting diodes (LEDs).

4. The turn signal according to claim 1, wherein the lights emit red or amber light.

5. The turn signal according to claim 1, wherein the plurality of lights are affixed along the entire length of the moving vehicle on both sides.

6. The turn signal according to claim 1, wherein the moving vehicle is a car, truck, motorcycle or a recreational vehicle.

7. The turn signal according to claim 1, wherein the lights are used as a hazard signal.
